(19) United States
(12) Patent Application Publication
(10) Pub. No.: US 2026/0155731 A1
(43) Pub. Date: Jun. 4, 2026

(54) DETERMINING A NEGATIVE CONTROL VOLTAGE

(71) Applicant: ZF Friedrichshafen AG, Friedrichshafen (DE)

(72) Inventors: Oliver Krone, Fleischwangen (DE); Robert Maier, Neudrossenfeld (DE)

(73) Assignee: ZF Friedrichshafen AG, Friedrichshafen (DE)

(21) Appl. No.: 19/407,971

(22) Filed: Dec. 3, 2025

(30) Foreign Application Priority Data
Dec. 3, 2024 (DE) 10 2024 211 543.6

(51) Int. Cl. H02M 1/00; B60L 3/00; H02M 1/08; H02M 7/5387

(52) U.S. Cl. CPC H02M 1/0054; B60L 3/003; H02M 1/08; H02M 7/5387; B60L 2240/527; B60L 2270/147

(57) ABSTRACT

A method for determining a negative control voltage for a control terminal on a passive semiconductor switch in a half bridge circuit in a traction converter for a vehicle includes: (a) setting an initialization value for the negative control voltage; (b) increasing the negative control voltage incrementally; (c) measuring emissions for determining an emission parameter indicating the strength of electromagnetic emissions when the traction converter is in use, based on the increased negative control voltage; (d) checking whether the emission parameter falls below a limit value; and repeating steps (b) through (d) until the emission parameter falls below the limit value.

### CROSS-REFERENCE TO RELATED APPLICATION

This application claims priority to German Patent Application No. 102024211 543.6, filed on December 3, 2024, the entirety of which is hereby fully incorporated by reference herein.

### TECHNICAL FIELD

The present disclosure relates to a method for determining a negative control voltage to a control terminal on a passive semiconductor switch in a half bridge circuit in a traction converter for a vehicle. The present disclosure also relates to a traction converter that has a half bridge circuit.

### BACKGROUND ART

Power electronics in electric and hybrid vehicles conducts traction power from the battery to the electric motor, and converts direct current into alternating current. There is an AC converter, or an inverter or traction converter for this. The switches (semiconductor switches) are formed by multiple transistors such as MOSFETs (metal-oxide-semiconductor field-effect transistors), IGBTs (insulated-gate bipolar transistors), or JFETs (junction field-effect transistors). A number of these semiconductor switches are interconnected in a half bridge circuit, one of which conducts the positive or negative voltage from the battery (the active switch), while the other (the passive switch) is turned off. By switching at a high frequency, an alternating current is obtained that can then be used by the electric motor. To increase the capacity, numerous power semiconductors are usually connected in parallel.

A positive (VCC) and negative (VEE) control voltage are used in the prior art for switching the power semiconductors. The positive control voltage is applied to the gate (control terminal) when in the “on” state, and the negative control voltage is applied to the gate for the “off” state. When the active switch is switched on, the gate voltage at the passive switch (with the negative control voltage) is increased due to the parasitic Miller effect. If the increase is too great, it can result in a parasitic turn-on (PTO) of the passive switch, which in turn causes high switching losses and may result in an unstable state of the semiconductor. To prevent this, the negative control voltage is selected in the current prior art to prevent a PTO at all operating points.

The high-frequency switching results in electromagnetic emissions (EME). These EME (or electromagnetic interferences (EMI)) are problematic, because they may disrupt the functioning of the electronic components. They also make it more difficult to comply with standards or other requirements for electromagnetic compatibility (EMC) that are necessary for ensuring that vehicles function reliably. Electromagnetic emissions in the relevant frequency ranges are substantially affected by the switching behavior of the power semiconductor.

### SUMMARY

Based on this, the present disclosure is concerned with the problem of reducing electromagnetic emissions (EME). Ideally, switching losses are to be kept low. Moreover, unstable states of the semiconductors should be prevented.

These problems are solved with the present disclosure by a method for determining a negative control voltage for a control terminal on a passive semiconductor switch in a half bridge circuit in a traction converter for a vehicle, comprising the steps:

(a) setting an initialization value for the negative control voltage;

(b) increasing the negative control voltage in increments;

(c) measuring emissions to determine an emission parameter that represents the strength of the electromagnetic emissions when the traction converter is in use, based on the increase in the negative control voltage;

(d) checking whether the emission parameter falls below a limit value, and repeating the steps (b) through (d) until the emission parameter falls below the limit value.

The present disclosure also relates to a traction converter with a half bridge circuit that has a negative control voltage determined with the method according to present disclosure.

Preferred embodiments of the present disclosure are also described herein. It is understood that the features specified above and explained below can be used not only in the given combinations, but also in other combinations or in and of themselves, without abandoning the scope of protection for the present disclosure. In particular, the traction converter can contain a half bridge circuit in which a negative control voltage is used for the semiconductor switch that has been determined with the approach described herein.

In accordance with the present disclosure, an initialization value is first set as the starting value for the negative control voltage. Starting with this initialization value, the negative control voltage is increased in increments over the course of numerous iterations, and the emissions are measured in order to determine or estimate the strength of the electromagnetic emissions. It can then be checked whether the emissions fall below or remain above a limit value that represents a maximum for the electromagnetic emissions. If the measurements remain above the limit value, the negative control voltage is increased, and the emissions are measured again. As soon as the electromagnetic emissions comply with the limit value, the process is stopped and the last negative control value that has been determined, or set, is used.

In this respect, an approach for determining a negative control voltage is proposed with which electromagnetic emissions, or interferences, are reduced. The present disclosure acknowledges that EME/EMI can be reduced when the negative control voltage is increased, in which case, parasitic turn-ons may be accepted. Specifically, parasitic turn-ons caused by Miller effects are accepted in order to prevent or avoid oscillations in the voltage and their associated emissions or interferences. The negative control voltage is repeatedly increased incrementally, until slight parasitic turn-ons occur, in order to thus prevent voltage oscillations.

Unlike in prior approaches for determining the negative control voltage, parasitic turn-ons at the passive semiconductor switch are accepted in the approach obtained with the present disclosure. It has been recognized that these parasitic turn-ons can have a damping effect on the drain-source voltage in the passive semiconductor switch. With this iterative process, the negative control voltage is never increased excessively. This prevents switching losses as well as unstable states of the semiconductor switches. With the prior art, the negative control voltage is normally selected such that any parasitic turn-ons are prevented, in particular to ensure that unstable states do not occur at any operating points. By accepting parasitic turn-ons, the electromagnetic emissions can be efficiently prevented. Consequently, as a result of the proposed increase in the negative control voltage obtained with the present disclosure, these emissions can be inexpensively prevented.

Preferably, the initialization value in step (a) is between -5 volts and 0 volts. Ideally, this value is between -5 volts and -3 volts, particularly between -5 volts and -4 volts. This initialization value can also be determined based on the type and/or structure of the semiconductor switch, using a previously determined value. Moreover, this initialization value can be selected in step (a) such that no parasitic turn-ons occur when switching the active semiconductor switch. The value for the negative control voltage is usually -5 volts or slightly higher. With current normal semiconductor switches, this voltage ensures a sufficient safety margin to a potentially unstable state, in order to prevent any undesired turn-ons.

This value, or a value that represents thus normally selected negative control voltage, is preferably used in the approach obtained with the present disclosure as the initialization value. Starting from this initialization value, the voltage is increased incrementally. This initialization value can be based on the type and structure of the semiconductor switch. Depending on which semiconductor switch is used, a different voltage, or negative control voltage, is obtained with which undesired turn-ons, or parasitic turn-ons, are impossible. This value can be used as the initialization value. This results in an efficient execution of the method, or an efficient means of obtaining a value for the negative control voltage with reduced electromagnetic emissions.

In a preferred embodiment, a predefined incremental value is used in step (b). This value can also be selected on the basis of the difference between the negative control voltage and a – preferably known – threshold voltage at which the passive semiconductor is switched on, potentially resulting in an unstable state. In particular, when the difference between the negative control voltage and the threshold value is small, the increment can be smaller. In other words, the incremental value can be reduced as the current negative control voltage approaches the threshold value in order to prevent a potentially unstable state. By selecting a predefined incremental value, the method obtained with the present disclosure can be efficiently initiated. By selecting an incremental value based on the difference between the negative control voltage and a threshold value voltage, the reliability of the selection of the negative control voltage is improved, enabling an efficient selection.

In a preferred embodiment of the method obtained with the present disclosure, emissions are measured in step (c) in a predefined frequency range. In particular, this predefined frequency range can be obtained from legal or other requirements, or standards. Normally, emissions are measured in specific frequency ranges for electromagnetic emissions. Depending on whether there are any emissions in this range, it can then be determined if they comply with the predefined limit value.

Emissions are preferably measured with a standardized and/or mandated process in step (c). This process can be legally mandated and/or described in a corresponding industrial standard. By using this type of standardized process for measuring electromagnetic emissions, a significant measurement is obtained.

It is preferably checked whether the passive semiconductor switch has been turned on in step (d), resulting in a potentially unstable state. In this case, steps (b) through (d) are not repeated. In this regard, a potentially unstable state forms an additional termination condition for continuing to incrementally increase the negative control voltage. If this is the case, the process is terminated. In this case, it is not possible to continue increasing the negative control voltage, and the value that has been reached is then regarded as the best possible value. This further increases safety.

The value can also be compared in step (d) with a predefined limit value. Specifically, the emission parameter can be compared with a predefined or preexisting limit value. This value can be provided by the manufacturer of the semiconductor switch. It can also be obtained from legal or industrial standards. Specifically, there can be a corresponding reference table for limit values based on the semiconductor technologies that are used. This results in an efficient assessment as to whether the electromagnetic emissions are acceptable or not.

The emission level is preferably compared in step (d) with a limit value according to the industrial standard, a legal requirement, and/or the manufacturer’s specifications. Specifically, it can be checked in step (d) whether a standard is complied with. This enables an efficient assessment as to whether or not the requirements have been observed.

The method obtained with the present disclosure preferably determines a negative control voltage for an SiC-MOSFET semiconductor switch. Specifically, this results in an advantageous application for SiC-MOSFET semiconductor switches. In this case, parasitic turn-ons may be acceptable in order to prevent oscillations and reduce electromagnetic emissions.

This semiconductor switch can be a transistor. By way of example, MOSFETs, IGBTs and JFETs can be used. Potentially, numerous identical or different semiconductor switches can be combined in a power semiconductor module, which are then connected in parallel. A semiconductor switch has a gate connection to which a positive or negative control voltage is applied in order to switch it on or off. An initialization value for a negative control voltage as well as an incremental value are voltage values that are below an (arbitrarily defined) initial value. The emission parameter can be a value based on an absolute or relative scale. By way of example, a non-dimensional value can also be used.

The present disclosure shall be described and explained in greater detail below in reference to the drawings, based on some selected exemplary embodiments.

### BRIEF DESCRIPTION OF THE DRAWINGS

FIG. 1 shows a schematic illustration of a side view of a vehicle with a battery, a traction converter, and an electric motor;

FIG. 2 shows a schematic illustration of the method obtained with the present disclosure;

FIG. 3 shows a schematic and simplified illustration of a circuit diagram for a gate-driver circuit;

FIGS. 4a and 4b show a schematic illustration of equivalent circuit diagram for illustrating the behavior of the gate-driver circuit at different negative control voltages;

FIG. 5 shows a schematic graph of the voltage curve over time at a passive switch when the active switch is turned on at different negative control voltages; and

FIG. 6 shows a schematic graph of the drain-source voltage at the passive semiconductor switch when the active switch is turned on at different negative control voltages.

### DETAILED DESCRIPTION

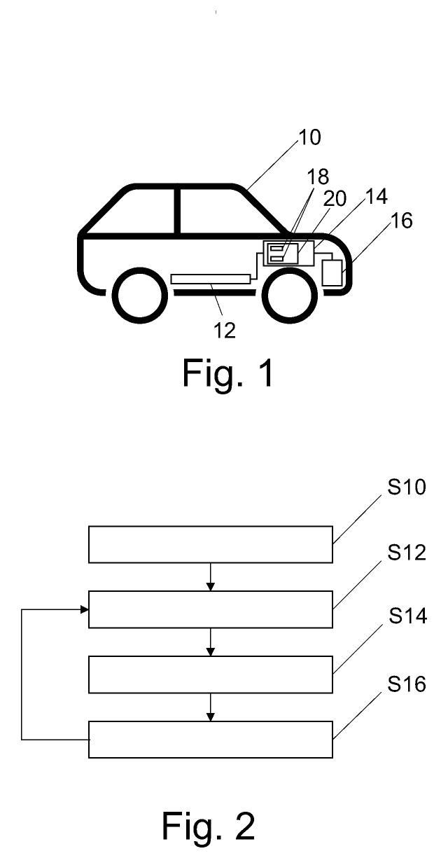

FIG. 1 shows a simplified schematic side view of a motor vehicle 10 with a battery 12, a traction converter 14 and an electric motor 16. There are two semiconductor switches 18 in a half bridge circuit 20 in the traction converter 14 for generating an alternating current for the electric motor 16. It is possible to determine a negative control voltage for preventing electromagnetic interferences or emissions, or complying with existing EMC requirements, with the method obtained with the present disclosure.

FIG. 2 schematically shows the method obtained with the present disclosure for determining the negative control voltage that is to be applied to a control terminal on a passive semiconductor switch in a half bridge circuit in a traction converter in a vehicle. The method comprises a step S10 for setting an initialization value for the negative control voltage. The method comprises a step S12 for increasing the negative control voltage. The method comprises a step S14 for measuring emissions. The method also comprises a step S16 for checking whether the electromagnetic emissions comply with a limit value for the electromagnetic emissions. Steps S12 through S16 are repeated if the emissions are within the limit value. The method can be a method for testing an automatic setting of a negative control voltage when testing or using traction inverters.

In the framework of the homologation of vehicle components (e.g. inverters, traction converters, or other power electronics components), it must be shown that certain (mandated) EMC limit values are not exceeded, or are complied with. The relevant limit values in this context are those obtained from legal standards, requirements set by the OEMs, or others. This is normally obtained with various EMC measurements with which the EMEs are measured at different frequencies. Specifically, the emissions from conductors and switches are measured.

Compliance with these EMC requirements in specific frequency ranges depends on the switching behaviors of semiconductor switches. Specifically, oscillations occur in the drain-source voltage, in the drain currents in the active MOSFETs, and in the voltage for turning off the passive/complementary SiC diodes, when turning on SiC-MOSFETs. The extents of these oscillations can have a strong impact on the EME. This relationship is simply due to the fact that a higher amplitude of the oscillations and longer continuation of these oscillations results in higher EME in the corresponding frequencies. Consequently, lower amplitudes of the oscillations and quicker fading thereof results in lower EME in the relevant frequencies. In practice, this is often a two-step process. First, the switching behavior is measured over a specific time period, and the optimization goal is pursued for reducing the oscillations with regard to their amplitudes and durations. Subsequently, the EMC is measured in order to check whether the EME within the observed frequency range have been sufficiently reduced to comply with the limit value.

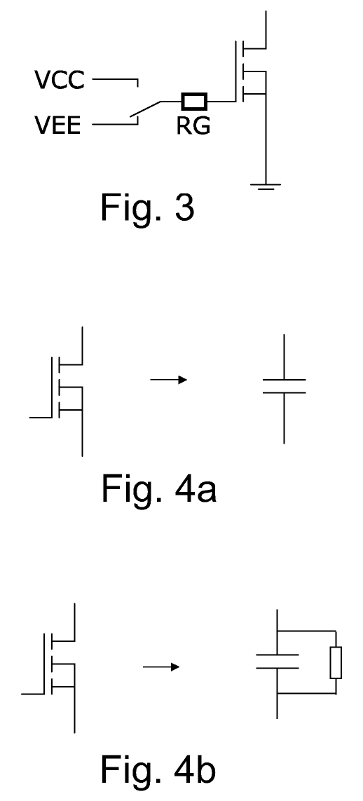

FIG. 3 shows how gate-driver circuits are used in the prior art in drive inverters in which a positive (VCC) and negative (VEE) control voltage are used for switching power semiconductors (specifically SiC-MOSFETs). The positive control voltage is applied to the gate (control port) when turned on, and is approx. +15 volts, for example. The negative control voltage is applied to the gate (control terminal) when turned off, and is -5 volts to 0 volts, for example.

FIGS. 4a and 4b show how the gate voltage may increase at the passive semiconductor switch (to which the negative control voltage is applied) when the active semiconductor switch is turned on. This increase may be triggered by the parasitic Miller effect. If the gate voltage at this point remains below the corresponding threshold voltage Uth for the channel (UGS < Uth), the passive semiconductor switch remains off. The equivalent circuit diagram for the passive semiconductor switch (or the free-wheeling diode) can be approximated as the capacitance in the relevant time interval (FIG. 4a) in this case. If the value falls below the threshold voltage Uth (UGS > Uth), a resistor is to be connected in parallel to the capacitor in the equivalent circuit diagram. This resistor forms a damper and reduces oscillations (FIG. 4b).

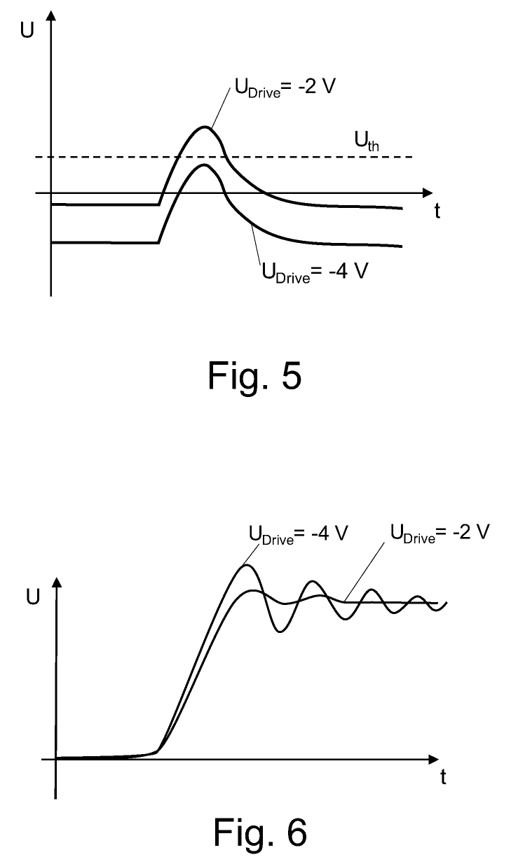

FIG. 5 is a graph showing the voltage curve at the control terminal for the passive switch for two different control voltages (-2V and -4V). This shows that the curve can be shifted by applying a different negative control voltage. With a negative control voltage of -4V, the gate voltage never reaches the threshold voltage Uth for the component indicated by the broken line. At a negative control voltage of -2V, the threshold voltage is exceeded, and the equivalent circuit diagram must be modified. This corresponds to a parasitic turn-on (PTO) of the semiconductor switch.

The effects of this damping are shown in FIG. 6, which shows the drain-source voltage at the passive semiconductor switch. Specifically, if the negative control voltage is increased too much, high switching losses occur, which may result in unstable states for the semiconductors. To ensure that these unstable states do not occur, the negative control voltage is normally selected in the prior art such that this value never falls below the threshold voltage, and a PTO is prevented at all operating points.

With the present disclosure, the negative control voltage is shifted to a range in which a soft PTO occurs, or can occur. This ensures that a potentially unstable state, i.e. a state with high switching losses, is prevented. The present disclosure proposes an iterative process for incrementally increasing the negative control voltage until a soft PTO occurs, thus reducing the oscillations. With the value for the negative control voltage obtained with this method, the EMC can be measured to check whether the corresponding limit values have been complied with. Depending on the results, it may then be possible to increase the negative control voltage. This process, or method, is completed when the value falls below the corresponding EMC limit value in the relevant frequencies, or when the semiconductor switch enters the potentially unstable state. In the second case, the safety margin to the unstable state is too small, and the negative control voltage must be lowered again.

In other words, the not generally known transitions between an operating range with a low PTO, reduced oscillations, as well as reduced EME are determined in an iterative process. PTOs are accepted in order to prevent EME.

The present disclosure has been comprehensively described and explained in the description and in reference to the drawings. The description and explanation are to be regarded as exemplary, and not limiting. The present disclosure is not limited to the disclosed embodiments. Other embodiments or variations can be derived by the person skilled in the art when using the present disclosure, or through a precise analysis of the drawings, the disclosure, and the claims.

In the claims, the words “comprise,” and “with” do not exclude the presence of other elements or steps. The indefinite articles “a” or “an” do not exclude pluralities. A single element or unit can execute the functions of numerous units specified in the claims. Simply specifying certain measures in numerous different dependent claims is not to be understood to mean that combinations of these measures cannot also be used advantageously. Reference symbols in the claims are not to be understood as limiting.

### Reference Symbols

10 vehicle

12 battery

14 traction converter

16 electric motor

18 semiconductor switch

20 half bridge circuit

1. A method for determining a negative control voltage for a control terminal on a passive semiconductor switch in a half bridge circuit in a traction converter for a vehicle, the method comprising:
(a) setting an initialization value for the negative control voltage;
(b) increasing the negative control voltage incrementally;
(c) measuring emissions for determining an emission parameter indicating a strength of electromagnetic emissions when the traction converter is in use, based on the increased negative control voltage;
(d) checking whether the emission parameter falls below a limit value; and
repeating (b) through (d) until the emission parameter falls below the limit value.

2. The method according to claim 1,
wherein the initialization value is -5V to 0V,
wherein the initialization value is selected on a basis of an existing value, depending on a type and/or structure of the semiconductor switch, and/or is selected such that no parasitic turn-on of the passive semiconductor switch occurs when switching an active semiconductor switch.

3. The method according to claim 1, comprising:
increasing the negative control voltage incrementally using a predefined incremental value; or
selecting the incremental value on a basis of a difference between the negative control value and a threshold voltage at which the passive semiconductor switch is turned on and a potentially unstable state occurs,
wherein the increment is reduced as the negative control voltage approaches the threshold value.

4. The method according to claim 1, comprising:
measuring emissions in a predefined frequency range.

5. The method according to claim 1, comprising:
measuring emissions with a standardized and/or mandated method.

6. The method according to claim 1, comprising:
checking whether the passive semiconductor switch has been turned on in step (d), and a potentially unstable state is obtained, wherein steps (b) through (d) are not repeated in response.

7. The method according to claim 1,
wherein comparison with a predefined limit value is carried out in step (d).

8. The method according to claim 1,
wherein comparison with a limit value is carried out in step (d) in accordance with an industrial standard, a legal requirement, and/or a manufacturer’s specifications.

9. The method according to claim 1,
wherein the method is configured to determine a negative control voltage for an SiC-MOSFET semiconductor switch.

10. A traction converter comprising:
a half bridge circuit with a negative control voltage for a control terminal on a passive semiconductor switch, wherein the negative control voltage is determined by:
(a) setting an initialization value for the negative control voltage;
(b) increasing the negative control voltage incrementally;
(c) measuring emissions for determining an emission parameter indicating a strength of electromagnetic emissions when the traction converter is in use, based on the increased negative control voltage;
(d) checking whether the emission parameter falls below a limit value; and
repeating (b) through (d) until the emission parameter falls below the limit value.

11. The traction converter according to claim 10,
wherein the initialization value is -5V to 0V,
wherein the initialization value is selected on a basis of an existing value, depending on a type and/or structure of the semiconductor switch, and/or is selected such that no parasitic turn-on of the passive semiconductor switch occurs when switching an active semiconductor switch.

12. The traction converter according to claim 10, wherein the negative control voltage is determined further by:
increasing the negative control voltage incrementally using a predefined incremental value; or
selecting the incremental value on a basis of a difference between the negative control value and a threshold voltage at which the passive semiconductor switch is turned on and a potentially unstable state occurs,
wherein the increment is reduced as the negative control voltage approaches the threshold value.

13. The traction converter according to claim 10, wherein the negative control voltage is determined further by:
measuring emissions in a predefined frequency range.

14. The traction converter according to claim 10, wherein the negative control voltage is determined further by:
measuring emissions with a standardized and/or mandated method.

15. The traction converter according to claim 10, wherein the negative control voltage is determined further by:
checking whether the passive semiconductor switch has been turned on in step (d), and a potentially unstable state is obtained, wherein steps (b) through (d) are not repeated in response.

16. The traction converter according to claim 10,
wherein comparison with a predefined limit value is carried out in step (d).

17. The traction converter according to claim 10,
wherein comparison with a limit value is carried out in step (d) in accordance with an industrial standard, a legal requirement, and/or a manufacturer’s specifications.

18. The traction converter according to claim 10,
wherein the semiconductor switch is an SiC-MOSFET semiconductor switch.
